(19) United States
(12) Patent Application Publication
(10) Pub. No.: US 2014/0251181 A1
(43) Pub. Date: Sep. 11, 2014

(54) Novel Film Composition

(71) Applicant: WINCOAT COLOURS AND COATINGS PRIVATE LIMITED, Thane (west) (IN)

(72) Inventor: Pradeep Tamhane, Thane (west) (IN)

(21) Appl. No.: 14/355,424

(22) PCT Filed: Oct. 31, 2012
(86) PCT No.: PCT/IN12/00718

§ 371 Date: Apr. 30, 2014

(30) Foreign Application Priority Data
Nov. 3, 2011 (IN) 3092/MUM/2011

(51) Int. Cl. C09D 101/28; A23L 1/00

(52) U.S. Cl. CPC C09D 101/28; A23L 1/0052
USPC 106/173.01; 106/194.2; 106/174.1

(57) ABSTRACT

This invention relates to the field of aqueous and non-aqueous film coating of substrates like pharmaceutical tablets, nutritional supplements, food, confectionery items, agricultural seeds, and the like, and is specifically concerned with coating substrates with a coating based on low molecular weight hydroxypropyl methyl cellulose having low viscosity. The invention provides a composition where it provides a relatively faster rate of coating than those known in the prior art. The invention also relates to method of preparing such rapid film coating composition.

### RELATED APPLICATION

This application is related to Indian Provisional Application 3092/MUM/2011 filed 3 Nov., 2011 and is incorporated herein in its entirety.

### FIELD OF INVENTION

This invention relates to the field of aqueous and non-aqueous film coating of substrates like pharmaceutical tablets, nutritional supplements, food, confectionery items, agricultural seeds, and the like, and is specifically concerned with coating substrates with a coating based on low molecular weight hydroxypropyl methyl cellulose having low viscosity. The invention provides a composition where it provides a relatively faster rate of coating than those known in the prior art.

### BACKGROUND OF THE INVENTION

The present disclosure relates to film forming compositions by the use of low molecular weight, low viscosity hydroxypropyl methyl cellulose coating compositions and coating compositions produced therewith.

The present disclosure also relates to method of making ready-mix/pre-mix film forming compositions.

The use of film coating technology has become well established in the pharmaceutical and other industries and has made great advances. Improved production equipment and development of highly efficient film coating formulations and polymers have accelerated the acceptance of film coating technology. Hydroxypropyl methyl cellulose (HPMC) was typically used in film coating formulations as a film forming polymer and remains in common usage. HPMC is obtained through a sumptuous serial procedure. Firstly, cellulose is extracted from either cotton flock or paper pulp and solubilised in sodium hydroxide solutions to obtain swollen cellulose. HPMC is subsequently obtained by treating the swollen cellulose with methyl chloride and propylene oxide. Finally, the mass is dried, comminuted and packaged after removal of dopants. HPMC is typically sold in several grades with different viscosities.

HPMC with viscosity 5 & 15 Cps are frequently used in tablets coating formulation. However, a limitation of the above HPMC polymers is rapid viscosity build upon dissolution in water & other organic solvents. Viscosity should be sufficiently low in order to facilitate atomization. The viscosity is mainly dictated by polymer concentration in the formulation. A lower polymer concentration of above forms lower viscosity, but also leads to relatively long coating times.

The use of Hydroxypropyl methyl cellulose with the short name Hypromellose/HPMC is generally used as a film forming polymer. Hypromellose is soluble in water & other organic solvents or their combinations such as Methylene chloride (MDC), Isopropyl Alcohol (IPA), Methanol, Acetone, Industrial spirit, Absolute alcohol etc. Also the same is stable up to pH 2 to 14 in any above mentioned solvents which emphasizes the use of Hypromellose in earlier mentioned solvents for film coating process.

The present invention provides a film forming composition comprising low molecular weight hydroxypropyl methyl cellulose of low viscosity grade less than 3 Cps, where it provides a faster rate of coating.

U.S. 2010/0275814 A1 provides a cellulose ether compositions with the use of low molecular weight HPMC.

U.S. Pat. No. 5,248,516 relates to the process for making an aqueous dispersion of a dry solid film-forming homogeneous particulate composition containing a film-forming water-soluble polymer, a plasticizer and an optional pigment.

U.S. 20060093560 provides a formulation where low molecular weight, water soluble polymer and at least one gum can be dispersed in water, along with other ingredients, at a temperature above the cloud point of the low molecular weight, water soluble polymer, leaving the low molecular weight, water soluble polymer undissolved and the viscosity of the dispersion manageable.

U.S. 20100285125 provides a formulation using a combination of low molecular weight polymers along with high molecular weight polymers.

U.S. Pat. No. 6,448,323 describes the film forming compositions with the use of Polyvinyl alcohol and other excipients.

Thus, the present composition provides a Novel composition that reduces the coating time and enhances the productivity.

### SUMMARY OF THE INVENTION

The present disclosure is directed to aqueous and non aqueous film forming compositions used in pharmaceutical tablets, nutritional supplements (Nutraceuticals), food & confectionary items, agricultural seeds & other similar products.

The present disclosure is also directed to aqueous film forming compositions used in pharmaceutical tablets, nutritional supplements (Nutraceuticals), food & confectionary items, agricultural seeds & other similar products.

The present disclosure is also directed to non-aqueous film forming compositions used in pharmaceutical tablets, nutritional supplements (Nutraceuticals), food & confectionary items, agricultural seeds & other similar products.

The present disclosure is also directed to methods for producing coating composition.

In one aspect the invention provides a composition with low molecular weight Hydroxypropyl methyl cellulose and/or other polymers, one or more plasticizer, optionally glidant, opacifier, colourants and optionally preservatives, sweeteners and flavours.

In second aspect the invention provides a process for preparing the composition which is carried out at 40° C. or less.

In third aspect the invention provides a coating compositions with low molecular weight hydroxypropyl methyl cellulose having low viscosity less than 3 Cps, the compositions having a colour acceptable for appearance-sensitive applications.

Surprisingly, it has been found that the present invention provides a composition in which coating time is considerably reduced to 2 hours or less, preferably to 1 hour or less and more preferably to 45 minutes or less and most preferably to 20 minutes or less.

Another advantage of the present invention is that it can make the reconstitution of coating formulation upto 20-25% w/w which significantly reduces the coating time about 50 to 60% than the conventional polymer systems.

Another advantage of the present disclosure is the composition is easily sprayable at low atomising pressure than the conventional coating composition.

The above summary of the present invention is not intended to describe each disclosed embodiment or every implementation of present invention. The detail description that follows more particularly exemplifies the illustrative embodiments, but should not be construed unduly limit this invention.

### DETAILED DESCRIPTION OF THE INVENTION

In accordance with the invention, the inventive film coating composition for use in coating pharmaceutical tablet, nutritional supplement, food, confectionery items, agricultural seed, and the like, comprises 1) low molecular weight, low viscosity Hydroxypropyl methyl cellulose less than 3 Cps, 2) atleast one plasticizer, optionally 3) glidant 4) opacifier, 5) colourants, preservatives, sweeteners and flavours.

In accordance with the invention, a method of coating substrates, such as pharmaceutical tablets, nutritional supplements, food, confectionery forms, agricultural seeds, and the like with a film coating, comprises the steps of mixing low molecular weight, low viscosity grade hydroxyproyl methyl cellulose less than 3 Cps, atleast one plasticizer, optionally a opacifier, a glidant and colourants, preservatives, sweetners and flavours. These excipients are blended dry.

In one embodiment, the temperature for coating process is 40° C. or less and preferably between 35 to 40° C. with the new invention.

In one embodiment, the invention provides a composition for film coating composition for use in coating pharmaceutical tablet, nutritional supplement, food, confectionery forms, agricultural seed, and the like, comprising 1) low molecular weight, low viscosity Hydroxypropyl methyl cellulose less than 3 Cps with single or in the combination of other polymers such as Hydroxy Propyl Methyl Cellulose (5 Cps/15 Cps), Ethyl Cellulose, Hydroxy Propyl Cellulose, Hydroxy Ethyl Cellulose, Polyvinyl Alcohol, Cellulose Acetate Phthalate, Hydroxy Propyl Methyl Cellulose Phthalate, Methacrylic acid co-polymer type B, Methacrylic acid co-polymer type C. with , 2) at least one plasticizer, & optionally 3) glidant 4) opacifier, 5) optionally colourants, preservatives, sweeteners and flavours where the coating time is considerably reduced.

The viscosity of low molecular weight hydroxypropyl methyl cellulose in the instant invention is less than 3.

It has been found that the coating time is considerably reduced to 2 hours or less, preferably to 1 hour or less and more preferably to 45 minutes or less and most preferably to 20 minutes or less with the use of the present composition.

Polymers are not limited to and are selected from group comprising Hydroxy Propyl Methyl Cellulose with viscosity less than 3 to 15 Cps, Ethyl Cellulose, Hydroxy Propyl Cellulose, Hydroxy Ethyl Cellulose, Polyvinyl Alcohol, Cellulose Acetate Phthalate, Hydroxy Propyl Methyl Cellulose Phthalate, Methacrylic acid co-polymer type B, Methacrylic acid co-polymer type C.

Plasticizer reduce the glass transition temperature of Hydroxypropyl methyl cellulose, making the film less brittle. These are not limited to and are selected from the group comprising Polyethylene Glycol 400, Polyethylene Glycol 4000, Polyethylene Glycol 6000, Polyethylene Glycol 8000, Diethyl Phthalate, Propylene Glycol, Castor Oil, Triacetin, Triethyl Citrate, Glycerin, Polysorbate 20, Polysorbate 40, Polysorbate 60, Polysorbate 80, Cetyl alcohol, sorbitan monooleate, hydrogenated vegetable oil, hydrogenated castor oil, dibutyl phthalate either alone or used in combination.

Glidants are used to improve the smoothness of the final coating. These are not limited to and are selected from the group comprising Talcum, Colloidal Silicon Dioxide, Sodium lauryl sulphate, Magnesium Stearate.

Opacifier are not limited to and are selected form the group comprising Talcum, titanium dioxide, lactose, calcium carbonate, heavy magnesium oxide, light magnesium oxide.

Colourants are not limited to and are selected form the group comprising allura red, brilliant blue, carmoisine, erythrosine, indigo carmine, ponceau 4R, quinoline yellow, sunset yellow, tartrazine, quinazarine green SS, alizarin cyanine green F, fast green FCF, eosin YS or eosin, toner red or sudan III, orange G, resorcin brown, naphthol blue black, patent blue, annatto, carotene, chlorophyll, cochineal, curcumin, caramel, riboflavin and oxide colours such as titanium dioxide, black iron oxide, red iron oxide, yellow iron oxide and pearlescent pigment.

Preservatives are not limited to and are selected from group comprising alkyl ester/s of parahydroxy benzoic acid, benzoic acid or it's salts, sorbic acid or it's salts.

In yet another embodiment, the invention provides a composition for film coating composition for use in coating pharmaceutical tablet, nutritional supplement, food, confectionery items, agricultural seed, and the like, comprising 1) low molecular weight, low viscosity Hydroxypropyl methyl cellulose less than 3 Cps and optionally other polymers such as Hydroxy Propyl Methyl Cellulose with viscosity less than 3 cps to 15 Cps, Ethyl Cellulose, Hydroxy Propyl Cellulose, Hydroxy Ethyl Cellulose, Polyvinyl Alcohol, Cellulose Acetate Phthalate, Hydroxy Propyl Methyl Cellulose Phthalate, Methacrylic acid co-polymer type B, Methacrylic acid co-polymer type C. 2) at least one plasticizer, & optionally 3) glidant 4) opacifier, 5) colourants, preservatives, sweeteners and flavours where the reconstitution level is between 20-25 w/w which subsequently reduces the coating time.

The percentage range of each component of the coating composition of the invention are as follows, by weight:

| | Acceptable | Preferred |
|---|---|---|
| Components | ranges % | ranges % |
| The Polymer Single | 25 To 75 | 30 To 65 |
| Hypromellose | | |
| Or | | |
| In combination with | | |
| Hydroxy Propyl Methyl Cellulose | | |
| with viscosity less than 3 to 15 | | |
| Cps, | | |
| Ethyl Cellulose, Hydroxy Propyl | | |
| Cellulose, Hydroxy Ethyl Cellulose, | | |
| Polyvinyl Alcohol, Cellulose Acetate | | |
| Phthalate, Hydroxy Propyl Methyl | | |
| Cellulose Phthalate | | |
| Methacrylic acid co-polymer type B | | |
| Methacrylic acid co-polymer type C | | |
| The Plasticiser (on the basis of polymer) | 5 To 30 | 5 To 25 |
| Single or in their combination | | |
| Polyethylene Glycol 400, | | |
| Polyethylene Glycol 4000, | | |
| Polyethylene Glycol 6000, | | |
| Polyethylene Glycol 8000 | | |
| Diethyl Phthalate | | |
| Propylene Glycol | | |
| Castor Oil | | |
| Triacetin | | |
| Triethyl Citrate | | |
| Glycerin & others | | |
| A Glidant | 5 TO 45 | 0 TO 25 |
| Talcum | | |
| Colloidal Silicon Dioxide | | |
| Sodium Lauryl Sulphate | | |
| A Opacifier | 0 TO 65 | 0 TO 55 |
| Titanium Dioxide | | |
| Calcium Carbonate | | |
| Heavy Magnesium oxide | | |
| Light Magnesium Oxide | | |
| The colourants (optionally) | Q.S | Q.S |
| Iron oxides | | |
| Aluminium Lake of food colours | | |
| Natural colours, water soluble colours | | |
| The Organoleptic ingredients | Q.S | Q.S |
| (optionally) | | |
| Preservatives, Sweeteners, Flavours | | |

The present invention will hereinafter be described in more detail with respect to following working examples, but the present invention is by no means limited to specific working examples, which may be properly changed or modified.

### EXAMPLES

### Example 1

| Composition | Percentage |
|---|---|
| Low molecular weight HPMC less than 4 Cps | 50.0 to 60.0 |
| Polyethylene Glycol 400 | 05.0 to 10.0 |
| Titanium Dioxide | 20.0 to 30.0 |
| Talcum | 08 to 15.0 |

| | | | Time |
|---|---|---|---|
| Qty of coating | | Weight gain | Required |
| material | Reconstitution | achieved | for coating |
| With 3% theoretical | Reconstitution Level: | 2.2% | 2 hours |
| weight gain | 8.0%. w/w | | |

### Example 2

| Composition | Percentage |
|---|---|
| Low molecular weight HPMC less than 4 Cps | 55.0 to 60.0 |
| Diethyl Phthalate | 07.0 to 15.0 |
| Titanium Dioxide | 10.0 to 20.0 |
| Talcum | 05.0 to 12.0 |
| Lake Tartrazine | 02.0 to 06.0 |
| Lake Brilliant Blue | 01.5 to 03.0 |

| | | Weight | Time |
|---|---|---|---|
| Qty of coating | | gain | Required |
| material | Reconstitution | achieved | for coating |
| With 3% theoretical | Reconstitution | 2.1% | 1 hours |
| weight gain | Level: 20.0%. w/w | | |

### Example 3

| Composition | Percentage |
|---|---|
| Hypromellose 5CPS | 50-60 |
| Polyethylene Glycol 400 | 05-10 |
| Polyethylene Glycol 6000 | 08-15 |
| Titanium Dioxide | 25-30 |
| Lake Quinoline Yellow | 0.1-0.35 |
| Yellow Iron Oxide | 0.3-0.75 |

| | | | Time |
|---|---|---|---|
| Qty of coating | | Weight gain | Required |
| material | Reconstitution | achieved | for coating |
| 5% weight gain | Reconstitution Level: 8.0%. | Initial weight gain up to 2.1% | 2 hours to 4 |
| | w/w | further coated with weight | hours |
| | | gain up to 4.2% | |

### Example 4

| Composition | Percentage |
|---|---|
| Low molecular weight HPMC less than 4 Cps | 50.0 to 57.0 |
| Polyethylene Glycol 400 | 05.0 to 13.0 |
| Polyethylene Glycol 6000 | 08.0 to 15.0 |
| Titanium Dioxide | 20.0 to 30.0 |
| Lake Quinoline Yellow | 0.05 to 1.0 |
| Yellow Iron Oxide | 0.05 to 1.5 |

| | | | Time |
|---|---|---|---|
| Qty of coating | | Weight gain | Required |
| material | Reconstitution | achieved | for coating |
| 5% weight gain | Reconstitution Level: | 2.1% further | 25 min for 2.1% |
| | 23.0%. w/w | coated with | weight gain, 40 |
| | | weight gain | min for 4.2% |
| | | up to 4.2% | weight gain |

### Example 5

| Composition | Percentage |
|---|---|
| Low molecular weight HPMC less than 4 Cps | 55.0 to 65.0 |
| Triethyl Citrate | 07.0 to 13.0 |
| Titanium Dioxide | 15.0 to 25.0 |
| Lake Erythrosine | 05.0 to 15.0 |

| | | | Time |
|---|---|---|---|
| Qty of coating | | Weight gain | Required |
| material | Reconstitution | achieved | for coating |
| With 6.5% theoretical | Reconstitution | 2.1% further coated with | 25 min for 2.1% |
| weight gain | Level: | weight gain up to 4.2% & | weight gain, 40 min |
| | 22.0%. w/w | 5.4% | for 4.2% weight gain |
| | | | & 1 hour for 5.4% |
| | | | weight gain |

### Example 6

| Composition | Percentage |
|---|---|
| Low molecular weight HPMC less than 4 Cps | 55.0 to 65.0 |
| Triethyl Citrate | 10.0 to 18.0 |
| Titanium Dioxide | 15.0 to 25.0 |
| Lake Erythrosine | 07.0 to 13.0 |

| | | | Time |
|---|---|---|---|
| Qty of coating | | Weight gain | Required |
| material | Reconstitution | achieved | for coating |
| With 6.5% | Reconstitution | 2.1% further | 25 min for 2.1% |
| theoretical | Level: | coated with | weight gain, 40 |
| weight gain | 22.0%. w/w | weight gain up to | min. for 4.2% |
| | | 4.2% & 5.4% | weight gain & |
| | | | 1 hour for 5.4% |
| | | | weight gain |

We claim:

1. A rapid film coating composition for use in solid forms such as pharmaceutical tablets, food, confectionary forms, nutraceuticals and the like comprising:
a) 25 to 75% of a low molecular weight, water soluble hydroxypropyl methyl cellulose having a viscosity of less than 3 cps;
b) 5 to 30% by weight of plasticizer;
c) 5 to 45% by weight of glidant;
d) 0 to 65% by weight of opacifier;
e) optionally colourants, preservatives, sweeteners, flavours
wherein the coating time is considerably reduced to 2 hours or less.

2. A rapid film coating composition of claim 1, wherein the coating time is reduced to 1 hour or less.

3. A rapid film coating composition of claim 1, wherein the coating time is reduced to 45 minutes or less.

4. A rapid film coating composition of claim 1, wherein the coating time is reduced to 20 minutes or less.

5. A rapid film coating composition of claim 1, further comprises low molecular weight water soluble polymer selected from the group consisting of hydroxyl propyl methyl cellulose with a viscosity less than 3 Cps to 15 Cps, ethyl cellulose, hydroxylpropyl cellulose, hydroxyl ethyl cellulose, polyvinyl alcohol, cellulose acetate phthalate, hydroxyl propyl methyl cellulose phthalate.

6. A rapid film coating composition of claim 1, wherein the plasticizer is selected from the group consisting of polyethylene glycol 400, polyethylene glycol 4000, polyethylene glycol 6000, polyethylene glycol 8000, diethyl phthalate, propylene glycol, castor oil, triacetin, triethyl citrate, glycerine & others.

7. A rapid film coating composition of claim 1, wherein the glidant is selected from the group consisting of talcum, colloidal silicon dioxide, sodium lauryl sulphate.

8. A rapid film coating composition of claim 1, wherein the opacifier is selected from the group consisting of titanium dioxide, calcium carbonate, heavy magnesium oxide, light magnesium oxide.

9. A method of preparing rapid film coating composition, wherein the method comprises dry blending of low molecular weight, low viscosity hydroxylpropyl methyl cellulose less than 3 cps, at least one plasticizer, optionally a opacifier, a glidant, colourants, preservatives, sweeteners, flavours where the temperature of coating process is 40° C. or less.

10. A method of coating rapid film coating composition of claim 9, wherein the temperature of coating process is 35° to 40° C.

11. A method of coating rapid film coating composition of claim 9, wherein the tablet bed temperature is 35° to 40° C.
